(19) United States
(12) Patent Application Publication
(10) Pub. No.: US 2006/0223040 A1
(43) Pub. Date: Oct. 5, 2006

(54) Interactive computer-assisted method of instruction and system for implementation

(76) Inventor: Edward Brown, Cleveland, TN (US)

Correspondence Address: DONNA J. RUSSELL, 1492 ANTHONY WAY, MT. JULIET, TN, 37122, US

(21) Appl. No.: 11/393,391

(22) Filed: Mar. 30, 2006

Related U.S. Application Data
(60) Provisional application No. 60/666,653, filed on Mar. 30, 2005.

(51) Int. Cl. G09B 3/00; G09B 23/24

(52) U.S. Cl. 434/298; 434/350

(57) ABSTRACT

The disclosure describes a system and method for providing computer-based instruction. The system provides a website that can be accessed via the internet in association with a series of instructional materials and at least one concept map for facilitating student understanding of the subjects presented by the instructional materials.

### CROSS-REFERENCE TO RELATED APPLICATIONS

This application claims the benefit of priority of earlier-filed U.S. Provisional application No. 60/666,653.

### FIELD OF THE INVENTION

The present invention relates to methods for providing educational instruction, particularly computer-assisted instruction.

### BACKGROUND OF THE INVENTION

Certain subjects have traditionally been considered more difficult for students to comprehend, and students often avoid these subjects because of their reputation for difficulty. Computer-assisted learning has made it possible to better individualize certain aspects of instruction, and to provide learning activities outside the classroom for individual students. Nevertheless, providing a conceptual framework to help students visualize and comprehend the relationships between various concepts often remains a challenge to teachers. This can be especially difficult in those subjects, such as chemistry, in which mathematical calculations and conversions may comprise a significant part of the work to be performed. Furthermore, in order to determine whether these concepts have been understood by the student, it is not sufficient for a teacher to simply check the answers to questions on homework, quizzes, or exams. Instead, evaluation of student understanding requires the instructor to review the process by which the student arrived at a correct or incorrect answer. This can be significantly more time-consuming than grading student work in other subjects.

What are needed are new and innovative methods for teaching these subjects so that students can better comprehend often difficult concepts and teacher time can be more efficiently utilized.

### SUMMARY OF THE INVENTION

The present invention relates to a computer-assisted instructional method and system for its implementation, the method comprising presenting to a student at least one concept map to illustrate the interrelated nature of concepts within a particular subject area, associating with the concept map factors that may be used to solve problems presented to the student in association with the concept map, and guiding students through the process of solving problems by assembling a problem-solving pathway from the factors selected by the student using the concept map.

The invention also relates to a system and a method of using the system for providing instruction in a subject area, the system comprising an internet-accessible or local network-accessible website and associated database to provide instructional materials to a user via a personal computer, the instructional materials comprising tutorials for presenting instruction in a given subject, at least one database comprising written exercises, at least one data input form associated with a written exercise, and an interactive concept map for assisting a student in visualizing concept relationships and using those relationships to solve problems presented by the written exercises. In one embodiment, the system further comprises a computer-assisted evaluation system for assessing student comprehension of concepts, the evaluation system comprising at least one set of questions, the questions optionally provided to the student in conjunction with a selection of correct and incorrect answers from which the student may be asked to choose the correct answer, a random generator of a subset of questions selected from the set of questions for presentation to the student as a quiz or test, and a timing mechanism for measuring the time required for the student to provide answers to a pre-selected number of quiz or test questions. The method of use of the evaluation system comprises providing to a student a set of questions randomly selected from a collection of questions stored in a database, providing to the student a means to input into the system the student's answers to each question in the set of questions, and assessing both the number of correct answers provided by the student and the time in which the student provided answers to all the questions in the set so that a student who answers all questions correctly for one quiz within a time specified by an instructor or who answers correctly all questions for multiple quizzes within a specified number of attempts is registered by the system as having completed the required test.

### BRIEF DESCRIPTION OF THE DRAWINGS

FIG. 1 is a diagram illustrating a system as described by the invention, where 1 is a computer operated by an instructor, 2 is a database, server, or internet router for accessing a website located on a server, and 3 is a computer operated by a student.

FIG. 2 illustrates a sample concept map as provided by the invention.

FIGS. 3a and b through FIGS. 8a and b illustrate steps in assembling a problem-solving equation using a concept map in the method of the invention.

### DETAILED DESCRIPTION

The inventor has developed a novel computer-assisted instructional method that is useful for teaching subjects in which a conceptual framework can be formed for interrelating concepts. Such subjects can include for example, chemistry, physics, mathematics, and languages. In one embodiment, the method is especially useful for teaching chemistry, particularly through laboratory exercises that illustrate the relationship between, for example, physical measurements such as length and volume or properties such as density or molarity.

In one embodiment of the invention, an instructional system for teaching chemistry through laboratory exercises and related problem-solving exercises is provided. Such a system can comprise, for example, an internet-accessible website and associated database providing tutorial presentations provided to a student using a computer operably connected to one or more central databases via the internet or a local network, written instructions for activities to be performed in a classroom or laboratory setting (i.e., written exercises), at least one data input form to provide students with access to the system to enter student-generated results based on the classroom or laboratory activities, and a concept map for assisting a student in solving problems related to the results of the classroom or laboratory activity.

Computer, server, and other elements for providing computer-assisted instruction via the internet are known to those of skill in the art. Programming languages and programs (e.g., Flash® (Adobe Systems, Inc.)) to facilitate performance of specific operations via computer are also known to those of skill in the art. The inventor has developed a system that utilizes those elements to deliver interactive instructional materials to students in conjunction with a concept framework for better understanding the information contained in the instructional materials. The system utilizes the known elements of servers, internet routers and modems, and personal computers in conjunction with the novel elements associated with the website and database that provide tutorial/pre-classroom activity presentations in an interactive manner to better prepare the student for participation in classroom activities. Students are more relaxed and prepared to learn when they better understand what they are asked to do in class, and have a better idea of the concepts that will be presented to them. In addition to the tutorials and pre-classroom activities, the system provides written descriptions of classroom activities and printable forms containing those written descriptions. In conjunction with the written descriptions of in-class or in-laboratory activities, the system provides both written and online questions and problem sets for students to answer. The system monitors the answers to online questions that are entered into the system, and determines, based upon criteria provided by the instructor, whether or not those answers fall within the acceptable criteria for a correct answer and whether or not credit will be entered for correctly answering a specific question. In conjunction with the questions and problem sets, the system also provides at least one concept map to the student to aid the student in visualizing the concepts and relationships that are applicable to the classroom or laboratory activities and the related problems and questions. The concept map is presented in an interactive fashion to allow the student to select appropriate portions of the map (e.g., by clicking a mouse when the onscreen cursor is located on or immediately adjacent to an icon or field) and thereby access the appropriate associated concept elements (e.g., by having those elements hyperlinked to the concept map), such as conversion factors, physical or chemical relationships, etc. for use in problem-solving activities. The system also provides a database of questions from which quizzes and tests may be formed by the system by randomly assembling subsets of questions based upon criteria entered into the system by a course instructor. These quizzes and tests may be presented to the student online, with online forms for entry of student answers into the system. The system can evaluate both the answers and the time in which those answers are input into the system by the student.

Although the examples provided herein are for instruction in the subject of chemistry, the system and method of the present invention can be utilized for instruction, and especially laboratory instruction, in a variety of subjects. In language laboratories, for example, students might be given choices between appropriate noun or verb forms for sentence construction, and the computer system could identify for the student those steps in sentence construction that the student has made in error.

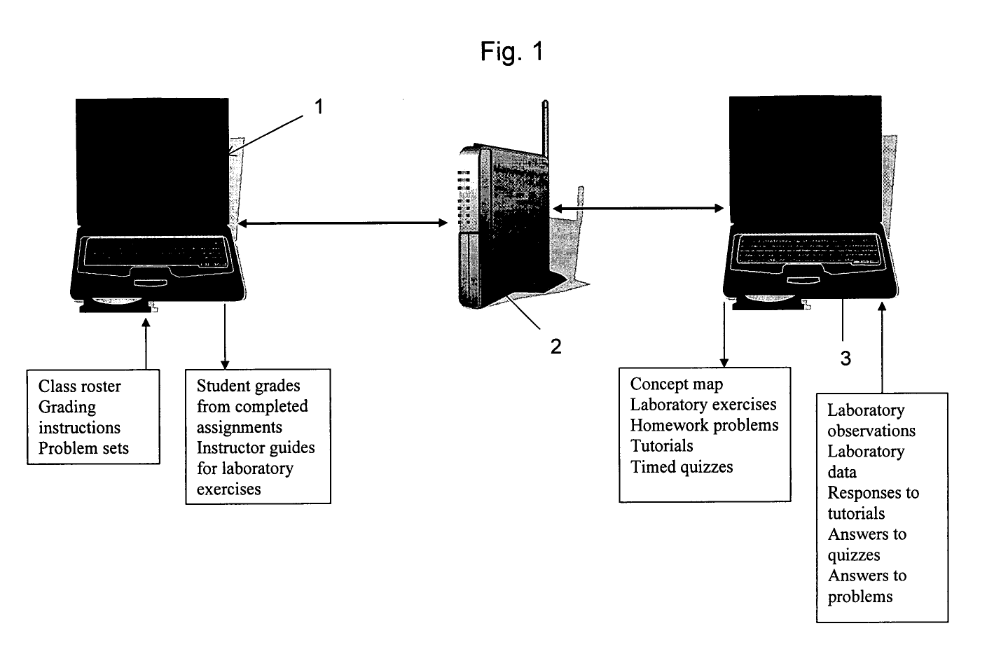

A system such as that provided by the present invention is shown in FIG. 1, where 1 is a computer operated by an instructor, 2 is an internet-accessible website comprising access to a database comprising instructional programs including tutorials and pre-class activities, written exercises and related questions, at least one concept map for teaching a student within a conceptual framework associated with the pre-class activities and written exercises, and, optionally, a testing program that evaluates both student answers and time of entry of those answers, and 3 is a computer operated by a student. In the system of the invention, the website provides tutorials, activities, problem sets and quiz questions presented in relation to a concept map to aid a student in visualizing the relationship between concepts such as, for example, units of measurement.

Instructors may access the system via a local computer connected to the internet and thereby connected to a website, to select one or more tutorials, or pre-laboratory exercises, for example, to be assigned to students prior to participation in a laboratory exercise. The one or more tutorials may be selected from a database of videos, presentations prepared using computer programs that provide animated presentations, such as Flash® (Adobe Systems, Inc.), PowerPoint® (Microsoft Corporation) presentations, or other audio, visual, or audiovisual presentations maintained within the system or they may be uploaded onto the system by the instructor if a suitable tutorial is not currently available within the database. An overview of chemistry labs may be provided using the concept map, and pre-laboratory tutorials may be assigned by an instructor so that students may be introduced to, or review, topics such as laboratory safety, laboratory techniques, and/or density, titration, conversion factors, cations and anions, and solubility rules. Students may be required to make decisions as they progress through a tutorial, and incorrect choices may send the student back to the beginning of the tutorial.

Upon completion of the assigned tutorial, a student may then be provided by the system with a written description of the laboratory exercise to be performed at the assigned laboratory time. Such written descriptions of laboratory exercises are maintained in a database of the system, preferably indexed by keywords and/or concept or subject categories so that they may be selected as needed by the instructor and made available to the student by the system at the appropriate time during the course of study. In one embodiment, laboratory exercises may be printed from the database by the student so that the laboratory manual is available in an “online” format for student use. Such written laboratory exercises may be provided by the system in, for example, Microsoft Words (Microsoft Corporation) format, WordPerfect® (Corel Corporation) format, portable document format (PDF) such as an Adobe® (Adobe Systems, Inc.) PDF document, or other suitable formats for viewing and printing by the student. By providing a database comprising a variety of laboratory activities that may be chosen by the instructor as needed for the laboratory course, the system may provide to the student only those laboratory exercises that will comprise a part of the actual hands-on laboratory course and thereby provide a laboratory manual that is available and accessible via the computer and, even if each laboratory exercise is printed in its entirety, a laboratory manual that does not consist of numerous unused exercises and wasted pages which are so common when standard written laboratory manuals are purchased by students as a course requirement.

A particular advantage of the current system is provided by at least one data input form provided to a student through internet webpage access via a personal computer, the data input form providing student access to the website database to enter his/her own individual data obtained through participation in the laboratory activity. The system can provide an instructor with the option of selecting from a class roster maintained in the database only those students who were identified by the instructor as having physically taken part in the laboratory activities, then restricting access to the data input form for that particular laboratory exercise to only those students who completed the required activities in the laboratory. Attendance in lab is recorded by the instructor on the website—directing the system to unlock the online data submission form of the system to only those students that attended the lab. For example, an instructor may access the class roster, deselect any missing students and submit that data to the system.

Calculations and observations are submitted online after the student completes the laboratory activities. The instructor may indicate to the system the number of submissions and the tolerance for variability of student data and answers to problems from that provided by the system or the individual instructor. Online post-lab problems may be associated with the lab report and assigned to the student to be completed when the lab report is due. For any student who is given access, the data input form in the system allows that student to enter the results obtained from the laboratory activity or activities and optionally perform calculations as requested by the instructor using those results. Desired values and/or value ranges for laboratory results may be indicated by the instructor at the time the online laboratory exercise is requested by the instructor from the system, and the system may indicate to a student whether the value entered falls within the desired range or not, whether a calculation performed using the entered value is correct, etc.

Calculations from laboratory results are often difficult for students in the sciences—particularly for those students in chemistry or physics courses. Students may have difficulty conceptualizing the relationship between various physical measurements and chemical quantities, for example, and often require assistance from the laboratory instructor. Unfortunately, many instructors have so many students that it is difficult to walk each student through the completion of such a dimensional analysis. The system and method of the present invention provide a means for aiding the student in understanding the interrelatedness of concepts and in problem-solving using those concepts. The system provides a valuable aid to the student in the form of a concept map. In one embodiment, the concept map may be provided in written form that may be printed by the student and in some embodiments a concept map may be provided as an interactive component of an internet- and/or local network-based module provided to the student via a personal computer.

In the method for providing computer-based instruction using a concept map, a student is provided with a concept map that is visually presented to the student on a computer screen or on paper. Preferably, the concept map is presented on-screen, and relationships between concepts are associated with the map by hyperlinking to the map additional information regarding those relationships so that a student may select a portion of the map and be presented with the information related to the relationship between two concepts, units, elements, etc. shown on the map. In one embodiment, a concept map is provided that visually presents units of length, mass, or volume. The relationship between any two units shown as connected on the map is hyperlinked to the connection or to either of the units, so that when a student selects that area of the map he or she is presented with a visual display of the conversion equation for converting one unit of length, mass, or volume to a related unit of length, mass, or volume. The student is thereby provided with a means for selecting the appropriate factors for assembling an equation to solve a problem associated with conversion of units and is assisting in solving the problem accordingly. In one embodiment, for example, a concept map may illustrate related concepts in the subject of chemistry, such as density, molar mass, and atomic weight.

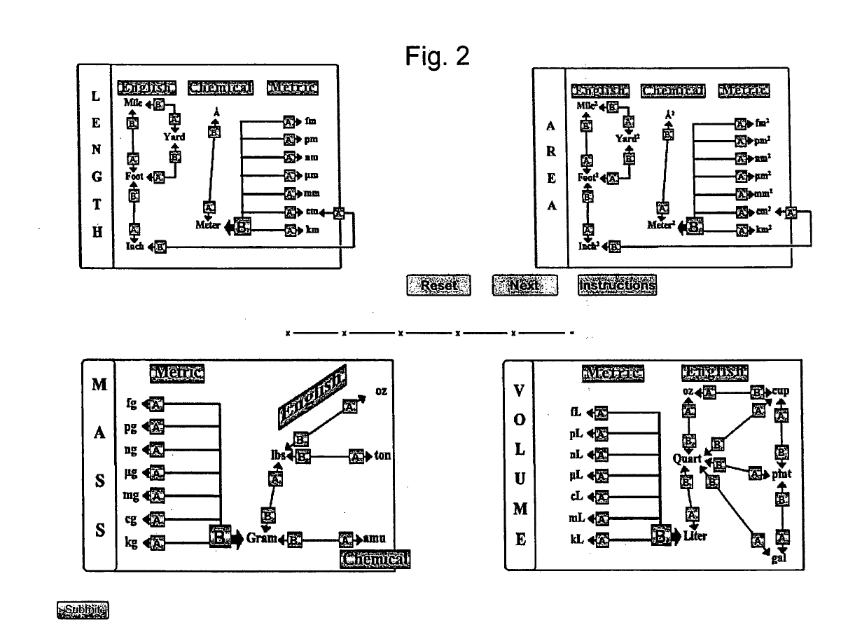

The concept map may display and visually connect related chemical units to reveal their mathematical relationship. By selecting a series of related units on the interactive map, conversion factor units are added to a growing dimensional analysis problem. By “dimensional analysis” (also called Factor-Label Method or the Unit Factor Method) is meant a problem-solving method that uses the fact that any number or expression or property of a substance (mass, volume, etc) can be multiplied by one without changing its value. In dimensional analysis, the one is a fraction where the numerator equals the denominator, but they have different units. When the value of interest is multiplied by a fraction where the denominator of the fraction has the same unit as the value of interest and the numerator has a different unit, then the value of interest can be expressed using the numerator's units. The map may be used to set up dimensional analysis problems involving common chemistry units. Once the route between the starting and ending units is traced on the map, the dimensional analysis problem is set up and the student is prompted to enter a number corresponding to each unit and the answer. The computer program then evaluates this information and reports incorrect entries in red. This map is used for questions assigned from the lecture (e.g., as homework) and the laboratory (e.g., as post-lab problems). As shown in FIG. 2, a typical chemistry concepts map may comprise a series of maps illustrating the relationships between units of length, area, mass and volume; cubic length, density (solid, liquid and gas); atomic mass units, moles and number of molecules; balancing equations, molar ratios and atomic ratios; molarity and titrations.

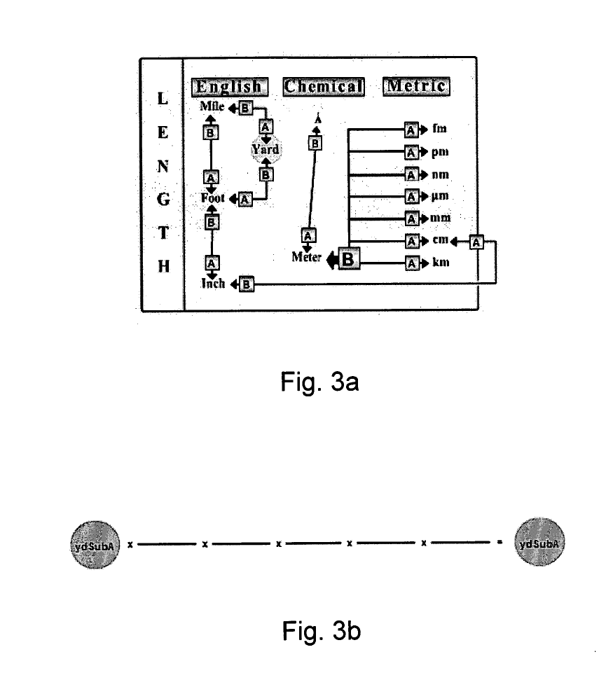

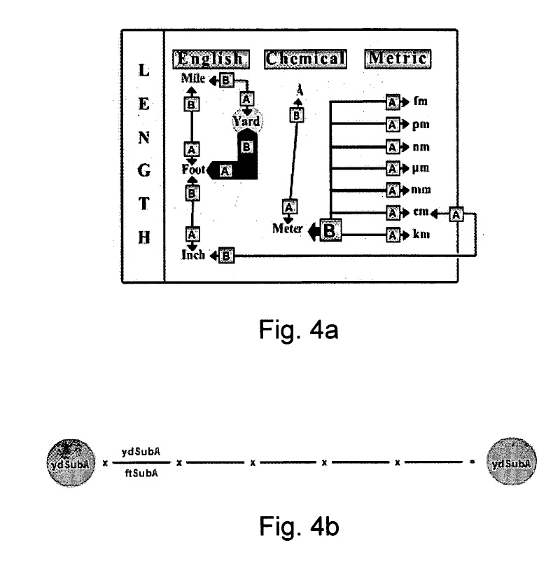

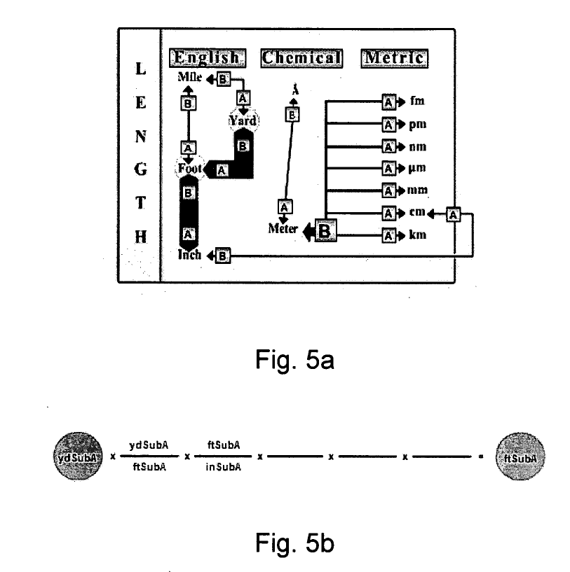

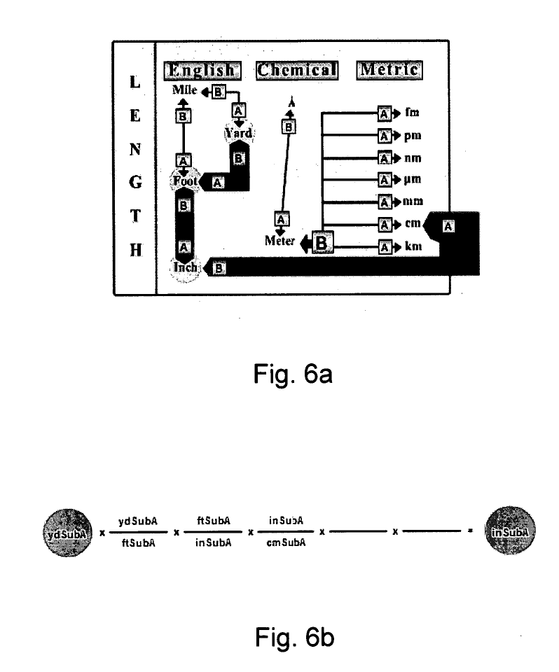

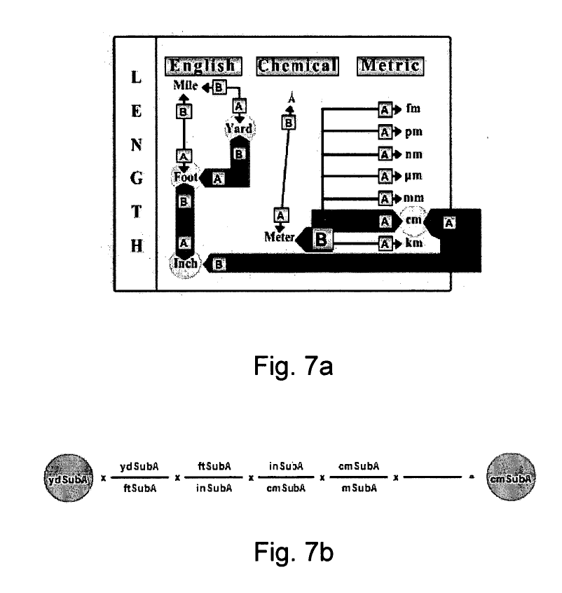

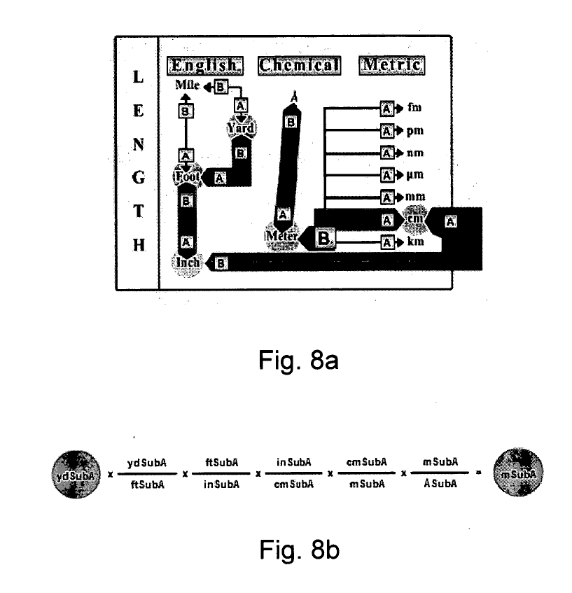

Turning to FIGS. 3a and b through FIGS. 8a and b, the series of figures illustrates an example of a problem-solving approach using a concept map as provided by the invention. When provided with a problem such as the conversion of 22 yards to Angstroms, a student can use the map to identify conversion factors that should be used to perform the desired conversion. The map links the units that are associated with the relationship between yards and Angstroms. As shown in FIGS. 3a and b through FIGS. 8a and b, as each intermediate unit is selected, an equation appropriate for performing the conversion of yards to Angstroms is assembled in step-wise fashion. Once the equation is provided, the student can enter the numeric units that are desired to be converted and the system calculates the answer.

As shown in FIG. 3a, a student may select a starting unit, such as yards, by clicking on the corresponding unit name, abbreviation, or symbol on the concept map. Once selected, the unit is placed by the system into the equation for conversation of the required units, as shown in FIG. 3b. The pathway from yards to Angstroms is indicated on the concept map, and the student need only select the series of steps in that pathway to assemble an equation appropriate for performing the conversion. As shown in FIG. 4a, yards may first be converted to feet, so when the student selects that step and thereby highlights it a shown in FIG. 4a, the conversion of yards to feet will be entered into the equation by the system. In the present example, feet may be converted to inches, as shown in FIG. 5a, so when the student selects that step the conversion of feet to inches is entered into the equation. As illustrated in FIG. 6a, inches may be converted to centimeters. When the students selects that step in the pathway, the unit conversion factors necessary to perform the conversion are entered into the equation, as shown in FIG. 6b. As FIG. 7a and FIG. 7b illustrate, selecting the step of converting centimeters to meters will add those units to the equation, and, as FIG. 8a and FIG. 8b illustrate, selecting the step of converting meters to Angstroms will add those units to the equation. Once the equation is assembled, the student must enter the appropriate numeric values for starting units and conversion factors (e.g., 3 ft./1 yd.) and then submit those entries to complete the problem.

Although the concept map has been described above as an internet-accessible web-based map and problem-solving system, it should be apparent to those of skill in the art that one or more concept maps and associated problem-solving programs may be provided to a student via a computer program on a compact disc or other data storage and transfer system that is computer compatible.

The system may also be used to construct quizzes and laboratory exams by choosing from among a variety of concepts and questions related to those concepts so that different students in any particular class will receive a different quiz or exam and that quiz or exam can be graded by the system so that both the answer and the method for arriving at the answer are evaluated. For each question that requires the student to perform at least one mathematical calculation, the system can be preset to recognize the conversion factors needed to perform the calculation and the student's work, and the answer can be checked by the system. If a set of three conversion factors are needed to perform a specific calculation, for example, the system will recognize those three factors in combination as a correct method for calculating the answer. If a student chooses less than the three factors, the missing factor will be noted for the student. If a student chooses one or more factors that will not aid in calculating the correct answer, the system will prompt the student to reconsider the choice(s) and input another conversion factor.

A series of online timed quizzes are made available to the student by the system as assigned by the instructor. The quizzes are structured to be completed in one of two ways: a student must score 100% and beat (or tie) the time established by the instructor and entered into the system by the instructor or a student must score 100% on multiple quizzes (without ever beating/tying the required time). The number of multiple quizzes required of the student in the second circumstance may be established by the instructor and the quizzes need not be consecutive. Generally, it has been common practice in the past to provide a test to a student a group of students and give them a predetermined time in which to complete the test. Students who understand the material sufficiently to answer a significant percentage of questions within the allotted time receive positive feedback and move on to the next lesson. Unfortunately, however, students who cannot answer a significant percentage of the questions correctly, or who cannot complete the questions in the required time, are penalized—yet no remedial action is taken at that time. An unsatisfactory grade is recorded and the student is expected to move on with the rest of the class to begin the next instructional unit. The system and method of the present invention provide an opportunity for students who have achieved mastery of the subject to complete the assigned quiz or test and then spend their time on other matters as they choose—but it does not simply penalize those who have not mastered the subject and force them to move on from that point without addressing their need to better understand the concepts that have just been presented to them. By providing a series of quizzes or tests to these students by computer-assisted means, it is possible to note their lack of comprehension at the time of the test while allowing them to continue to try to master the subject material through a series of repetitive quizzes that make them think about the question and the answer and focus their attention on the material.

An instructor may customize each timed quiz by removing elements from the quiz, setting the time, setting the number of times and determining the points. When the student first selects the quiz on the computer screen, he/she is given information about the quiz and shown the information (selected by the instructor) that will be on the quiz. The answers to the quiz may be posted on the same page as the quiz. If a student has already mastered the material, he/she will be able to quickly answer the questions within the allotted time. If a student must look at the answers, he/she will not be able to complete it in the minimum time and will be required to take multiple quizzes. In the method of the invention, a student may receive credit for completing a quiz within one attempt or within multiple attempts. Students who quickly master the concepts and are able to correctly answer the questions are therefore free to complete the assignment and devote their time to other endeavors. Exams given in timed format can aid an instructor in determining whether a student has internalized the concept sufficiently to be able to recall it quickly, or the student must look up the information required to answer the question—a process that may require significantly more time. For those students who can answer the required number of questions in the assigned time, the grade is recorded upon completion of the quiz or exam. For those students who cannot answer the required number of questions in the allotted time, the instructor may require that the student take a series of quizzes or exams that cover the same concepts. These may comprise the same questions, but more preferably would provide a new set of questions related to the same concepts so that the student must think about the concept in order to attempt to answer the new question regarding the same concept. These questions may be randomly generated to form a series of quizzes or exams that the student can take until a required number of questions are correctly answered in a prescribed time, or a required number of quizzes or exams are taken to provide the student with an opportunity to focus on the concept and, through spaced repetition, to learn those concepts that were unclear to the student upon beginning the first quiz or exam.

Instructor's guides may be provided to give information about solution preparation and numbering of unknowns so that computer grading of laboratory data and calculations will be more uniform. Waste disposal and MSDS information may also be provided to an instructor via the system.

An electronic grading key may be established by the instructor by inputting instructor preferences into the system regarding grading of online laboratory reports, problem sets, and timed quizzes. The instructor may assign the points for timed quizzes, pre-lab exercises, homework assignments, laboratory observations, laboratory calculations, laboratory results and laboratory attendance, for example. The system may grade all of the above for the instructor (per the electronic grading key) except for those laboratory observations, results, etc. that the instructor may wish to review. Reference items such as an interactive periodic table/molar mass calculator or scientific calculator may also be accessed on the website to aid the student in completing the required questions and problems.

The invention has been described with reference to various specific and preferred embodiments and techniques. However, it should be understood that many variations and modifications may be made while remaining within the spirit and scope of the invention.

What is claimed is:

1. A method for providing computer-assisted instruction in problem-solving comprising
a) presenting to a student at least one concept map to illustrate the interrelated nature of concepts within a particular subject area;
b) associating with the concept map factors that may be used to solve problems presented to the student in association with the concept map; and
c) assembling a problem-solving pathway from the factors selected by the student using the concept map.

2. The method of claim 1 wherein the concept map illustrates related concepts in the subject of chemistry.

3. The method of claim 1 wherein the step of associating with the concept map factors that may be used to solve problems is performed by hyperlinking one or more factors to an on-screen hidden or visible icon associated with a relationship between two concepts or measurements.

4. A method for evaluating student comprehension of subjects presented in instructional materials, the method comprising
a) providing to a student a set of questions randomly selected from a collection of questions stored in a database,
b) providing to the student a means to input into the system the student's answers to each question in the set of questions, and
c) assessing both the number of correct answers provided by the student and the time in which the student provided answers to all the questions in the set so that a student who answers all questions correctly for one quiz within a time specified by an instructor or who answers correctly all questions for multiple quizzes is registered by the system as having satisfactory comprehension of the subjects.

5. An instructional system for teaching a subject through classroom or laboratory activities and related problem-solving exercises, the system comprising
a) an internet-accessible website and associated database providing tutorial presentations provided to a student using a computer operably connected to one or more central databases via the internet or a local network;
b) written instructions for activities to be performed in a classroom or laboratory setting;
c) at least one data input form to provide students with access to the system to enter student-generated results based on the classroom or laboratory activities; and
d) at least one concept map for assisting a student in solving problems related to the results of the classroom or laboratory activity.
